(19) United States
(12) Patent Application Publication
(10) Pub. No.: US 2025/0245570 A1
(43) Pub. Date: Jul. 31, 2025

(54) PRETEXT TRAINING FOR EVENT SEQUENCES IN MACHINE LEARNING

(71) Applicant: Royal Bank of Canada, Toronto (CA)

(72) Inventors: Yimu Wang, Waterloo (CA); Frederick Tung, North Vancouver (CA); Ruizhi Deng, Coquitlam (CA); He Zhao, Richmond (CA)

(21) Appl. No.: 19/041,768

(22) Filed: Jan. 30, 2025

Related U.S. Application Data
(60) Provisional application No. 63/627,401, filed on Jan. 31, 2024.

(51) Int. Cl. G06N 20/00

(52) U.S. Cl. CPC G06N 20/00

(57) ABSTRACT

A method for training a machine learning engine for event sequence tasks comprises pre-training the machine learning engine using unsupervised learning on at least one pretext task using pretext training data to obtain a partially trained machine learning engine, where the pretext training data comprises pretext event sequences. The method may further comprise, after pre-training the machine learning engine to obtain the partially trained machine learning engine, further training the partially trained machine learning engine on a target task using target task training data to obtain a task-trained machine learning engine, where the target task training data comprises target task event sequences.

### CROSS-REFERENCE TO RELATED APPLICATION

This application claims the benefit of U.S. Provisional Application No. 63/627,401 filed on Jan. 31, 2024, the teachings of which are hereby incorporated by reference.

### TECHNICAL FIELD

The present disclosure relates to machine learning, and more particularly to the application of machine learning to event sequences.

### BACKGROUND

Event sequence data captures the occurrence of irregularly spaced discrete events in time. Some representative examples are sequences of online purchasing activities or other financial transactions, and recordings of patients' medical measurements in a clinical setting. These are merely non-limiting illustrative examples. In real-world applications, machine learning technology can be used to make decisions, or to support human decision-makers, by analyzing such data. For example, sequences of online purchasing activities or other financial transactions can be analyzed to predict or recognize fraudulent transactions, or recordings of patients' medical measurements can be used in disease diagnosis. In such contexts, it would be desirable to have a machine learning engine that can learn representations from event sequence data in a way that supports reliable inferences and can generalize well over diverse tasks.

However, most current approaches use specialized methods for the task of interest, which makes it difficult to modify the machine learning models for a different downstream task than that for which they were trained, and it is often necessary to retrain the entire model to adapt it to a new task. This adds to the challenge of practical deployment. Moreover, conventional event sequence models cannot learn from unlabeled data.

### SUMMARY

The present disclosure describes a technological improvement in the form of a learning framework for machine learning of event sequence data. The learning framework comprises pre-training an event sequence using pretext tasks, which may include customizations of masked-reconstruction, contrastive learning and alignment verification as pretext tasks for event sequence data. The pre-training may then be followed by further training (fine-tuning) of the pre-trained model to adapt it for specific tasks. The approach can be applied to TPP tasks, as well as to classification tasks and interpolation tasks for irregular time series data.

In one aspect, a method for training a machine learning engine for event sequence tasks comprises pre-training the machine learning engine using unsupervised learning on at least one pretext task using pretext training data to obtain a partially trained machine learning engine, where the pretext training data comprises pretext event sequences. In some embodiments, the pretext event sequences are pretext asynchronous event sequences. In other embodiments, the pretext event sequences are pretext regular event sequences.

The method may further comprise, after pre-training the machine learning engine to obtain the partially trained machine learning engine, further training the partially trained machine learning engine on a target task using target task training data to obtain a task-trained machine learning engine, where the target task training data comprises target task event sequences of a same type as the pretext event sequences. In some embodiments, the pretext event sequences are pretext asynchronous event sequences and the target task event sequences are target task asynchronous event sequences. In other embodiments, the pretext event sequences are pretext regular event sequences and the target task event sequences are target task regular event sequences. The pretext training data and the target task training data may be drawn from a single set of combined training data comprising a combined set of event sequences, or the pretext training data may be drawn from a first set of training data comprising a first set of event sequences and the target task training data may be drawn from a second set of training data comprising a second set of event sequences. The first set of event sequences and the second set of event sequences may be overlapping sets, or the first set of event sequences and the second set of event sequences may be mutually exclusive sets.

In some embodiments, the pretext task(s) may comprise masked reconstruction, which may comprise density-preserving masking.

In some embodiments, the pretext task(s) may comprise contrastive learning, which may comprise at least one of sub-sequence augmentation, masked event augmentation, and noisy data augmentation.

In some embodiments, the pretext task(s) may comprise at least one alignment verification task, which may comprise at least one binary classification task. Where the pretext event sequences are pretext asynchronous event sequences, the alignment verification task(s) may incorporate at least one of randomly shuffled views of the pretext asynchronous event sequences, randomly swapped views of the pretext asynchronous event sequences, and random combination views of the pretext asynchronous event sequences.

Where the pretext event sequences are pretext asynchronous event sequences and the target task event sequences are target task asynchronous event sequences, the target task may be a temporal point process (TPP) task. The TPP task may be performed using a transformer, preferably a Hawkes transformer, more preferably an Attentive Neural Hawkes Process.

The target task may be a classification task for irregular time series data, or an interpolation task for irregular time series data.

In other aspects, the present disclosure is directed to a data processing system for implementing any of the above-described methods, and to a computer-program product embodying instructions for implementing any of the above-described methods.

### BRIEF DESCRIPTION OF THE DRAWINGS

These and other features will become more apparent from the following description in which reference is made to the appended drawings wherein:

FIG. 1 is a schematic representation of an illustrative method for training a machine learning engine for event sequence tasks;

FIG. 1A shows an embodiment of the representation of FIG. 1 in which pretext training data and target task training data are drawn from a single set of combined training data comprising a combined set of event sequences;

FIG. 1B shows an embodiment of the representation of FIG. 1 in which pretext training data and target task training data are drawn from mutually exclusive sets of event sequences;

FIG. 1C shows an embodiment of the representation of FIG. 1 in which pretext training data and target task training data are drawn from overlapping sets of event sequences;

FIG. 1D shows an embodiment of the representation of FIG. 1 in which the pretext training data comprises pretext asynchronous event sequences and the pretext task comprises alignment verification incorporating at least one of randomly shuffled views, randomly swapped views, and random combination views;

FIG. 2 is a flow chart showing an illustrative method for training a machine learning engine for event sequence tasks;

FIG. 3 is a graph showing a comparison between a baseline model and a machine learning engine according to the present disclosure in respect of a number of layers;

FIG. 4 is a graph showing a comparison between a baseline model and a machine learning engine according to the present disclosure in respect of the number of dimensions; and

FIG. 5 shows an illustrative computer system in respect of which aspects of the present technology may be implemented.

### DETAILED DESCRIPTION

### Pre-Training in Machine Learning

Learning generalizable and transferable representations has advanced the state-of-the-art performance of machine learning research. A considerable body of work has found that combining pretext training and fine-tuning works well in contexts other than event sequence data.

In language modeling, BERT (Devlin et al., 2018) presents two pre-training tasks-masked language model and next sentence prediction. This leads to powerful models that can be deployed across various tasks, such as question answering, sentiment analysis, and named entity recognition. Similarly, research in respect of GPTs (Radford et al., 2019; Brown et al., 2020) found that using next-prediction as the pre-training objective over a larger scale of data and model capacity can yield significant improvements. In computer vision, supervised ImageNet (Russakovsky et al., 2015) pre-training has had a positive impact on tasks such as object detection (Ren et al., 2015), segmentation (Liu et al., 2021) and cross-modal retrieval (Radford et al., 2021). More recently, the unsupervised version of such pre-training has also highlighted the ability of such models to learn robust and useful representations from image data without labels (He et al., 2022). In time series analysis, recent works following approaches similar to the above have made significant progress in regular time series (Franceschi et al., 2019; Tonekaboni et al., 2021; Zerveas et al., 2021; Yue et al., 2022) and irregular time series (Chowdhury et al., 2023) on diverse tasks, such as classification, interpolation, and forecasting. However, pre-training methods are not prevalent in event sequence data.

### Overview of Pretext Training for Event Sequences

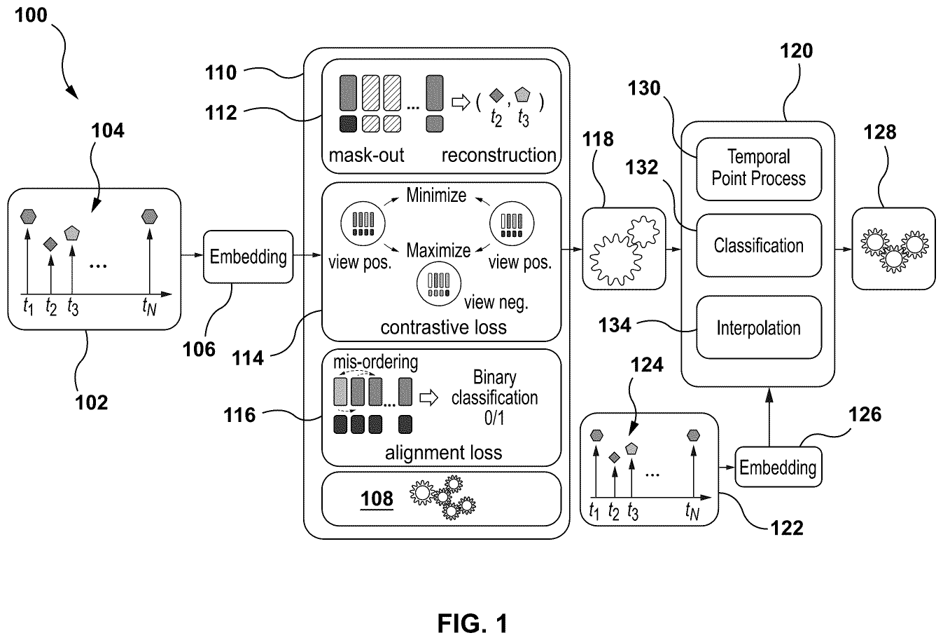

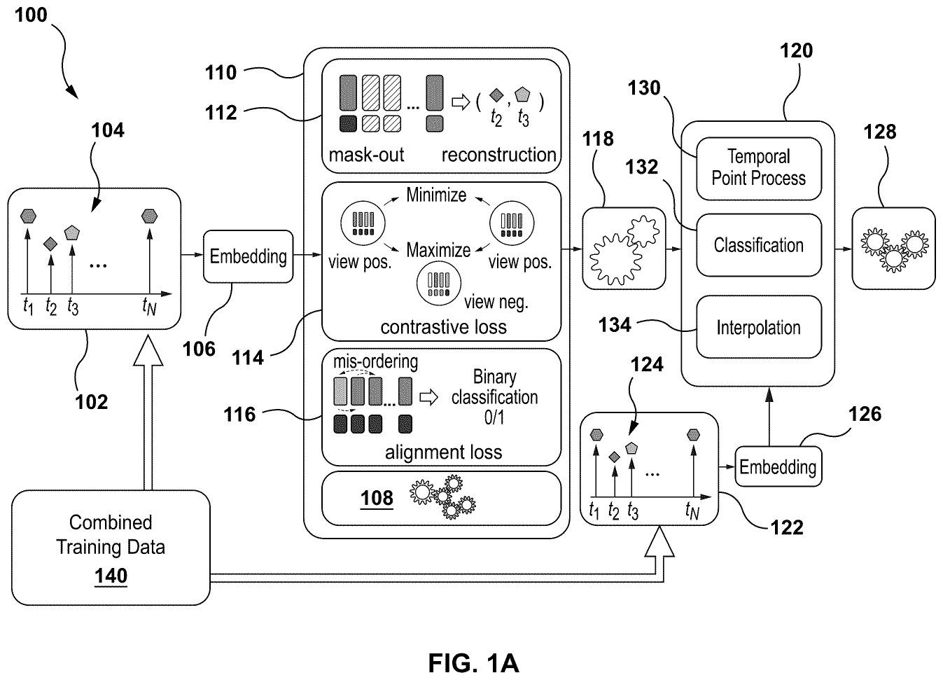

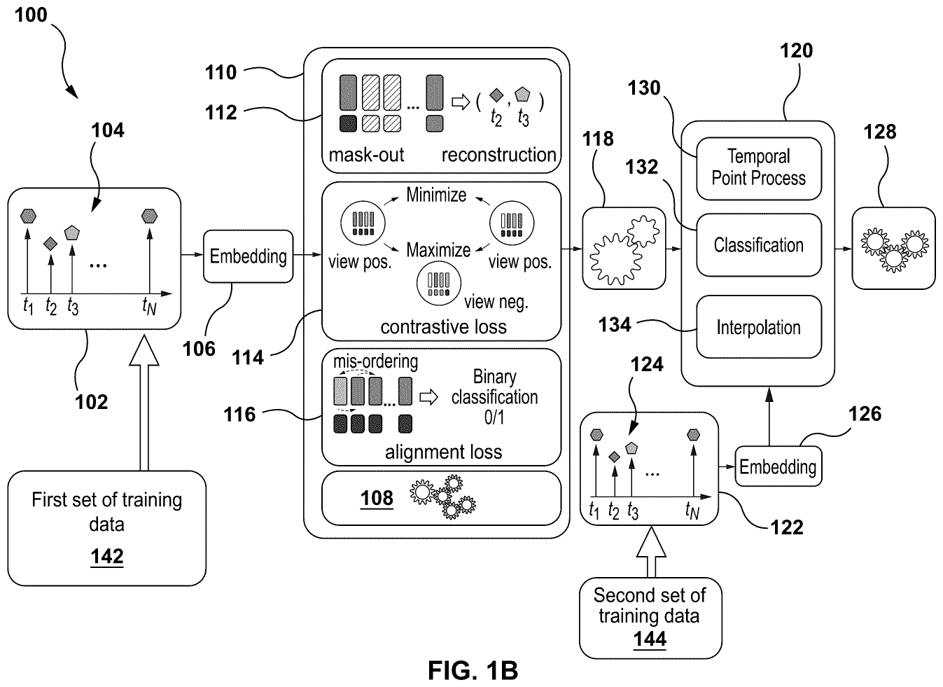

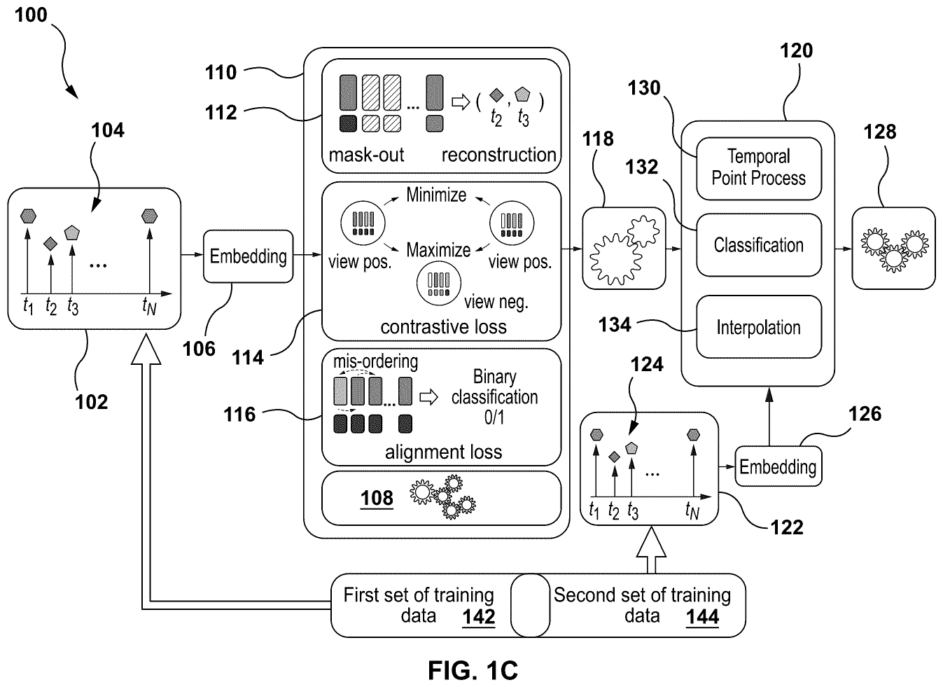

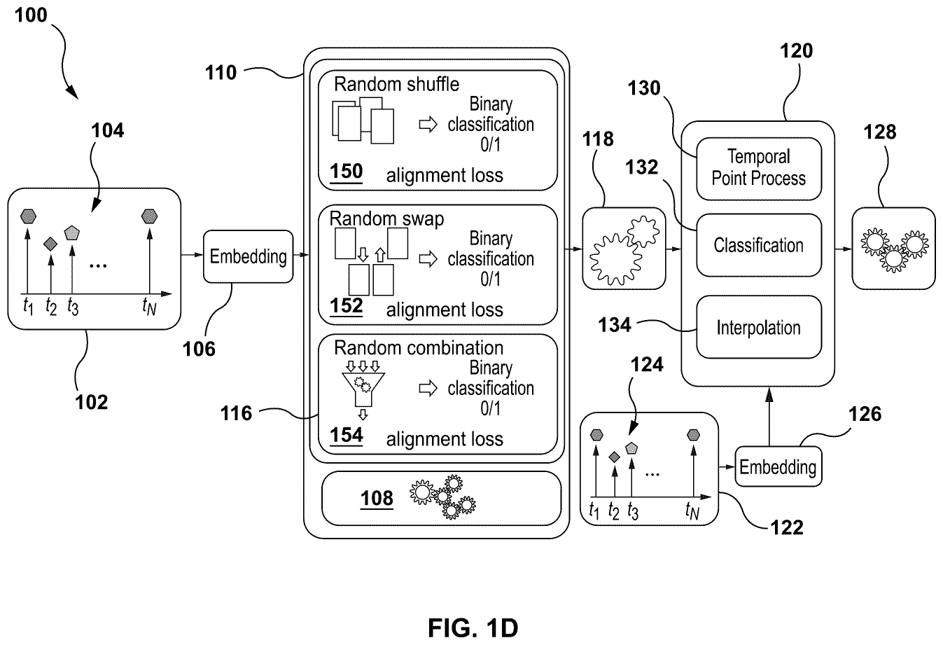

Reference is now made to FIG. 1, which is a schematic representation of an illustrative method 100 for training a machine learning engine for event sequence tasks. While the methods described herein may be applied to training a machine learning engine for regular event sequence tasks, they have particular applicability to training a machine learning engine for asynchronous event sequence tasks. The term “asynchronous event sequence” refers to an event sequence in which the events are not temporally evenly spaced apart, as distinguished from a regular event sequence. As shown in FIG. 1, pretext training data 102 comprising pretext event sequences 104 is embedded 106 and used to pre-train a machine learning engine 108 using unsupervised learning 110 on at least one pretext task. The pretext event sequences 104 may be asynchronous event sequences (“pretext asynchronous event sequences”) or regular event sequences (“pretext regular event sequences”). A pretext task is a task that is used to train a machine learning engine, but that is different from the target task that the trained machine learning engine is ultimately to perform; the use of pretext training typically precedes further training for the target task, and the use of pretext tasks in this context is referred to as pre-training. In the illustrative embodiment, the pretext tasks may comprise one or more of masked reconstruction 112, contrastive learning (using contrastive loss) 114, and alignment verification (using alignment loss) 116. The aforementioned pretext tasks 112, 114, 116 used for the unsupervised learning 110 are merely illustrative and not limiting. The result of the unsupervised learning 110 is a partially trained machine learning engine 118.

After pre-training the machine learning engine 108 to obtain the partially trained machine learning engine 118, further training 120 (also referred to as fine-tuning) is applied to the partially trained machine learning engine 118. Typically, the further training 120 is a supervised learning step that adapts the model implemented by the partially trained machine learning engine 118 to a specific task, i.e. a target task. In some embodiments, there may be more than one target task. The further training 120 uses target task training data 122 comprising target task event sequences 124; the target task training data 122 is embedded 126 for use in the further training 120. The target task event sequences 124 may be asynchronous event sequences (“target task asynchronous event sequences”) or regular event sequences (“target task regular event sequences”), depending on whether the pretext event sequences 104 were pretext asynchronous event sequences or pretext regular event sequences. Both the pretext event sequences 104 and the target task event sequences 124 must be of the same type, i.e. either both are asynchronous event sequences or both are regular event sequences. The result of the further training 120 is a task-trained machine learning engine 128 which is adapted to a particular target task. In some embodiments, the target task may be a temporal point process (TPP) task, in which case the further training 120 may comprise temporal point process training 130. Any suitable TPP handling may be used. In other embodiments, the target task may be a classification task for irregular time series data and the further training 120 may comprise classification training 132 for the classification task for the irregular time series data. In still other embodiments, the target task may be an interpolation task for irregular time series data and the further training 120 may comprise interpolation training 134 for the interpolation task for the irregular time series data. The term “irregular time series data” refers to data resulting from a continuous signal that is sampled at irregular time intervals.

Additional training and/or tuning may be applied to the task-trained machine learning engine 128.

The word “pretext” as used in the terms “pretext training data” and “pretext event sequences” is used to indicate training data (comprising event sequences) that are used for pre-training with pretext tasks. Similarly, the word “target task” in the terms “target task training data” and “target task event sequences” is used to indicate training data (comprising event sequences) that are used for further training (fine-tuning) for the ultimate target task. Thus, the terms “pretext” and “target” in this context are used as labels denoting the use of the training data comprising event sequences, rather than their underlying characteristics.

As shown in FIG. 1A, in one embodiment the pretext training data 102 and the target task training data 122 may be drawn from a single set 140 of combined training data comprising a combined set of event sequences. In other embodiments, as shown in FIGS. 1B and 1C, the pretext training data 102 may be drawn from a first set 142 of training data comprising a first set of event sequences and the target task training data 122 may be drawn from a second set 144 of training data comprising a second set of event sequences. In the latter cases, the first set of event sequences and the second set of event sequences may be mutually exclusive sets as shown in FIG. 1B, or may be overlapping sets as shown in FIG. 1C.

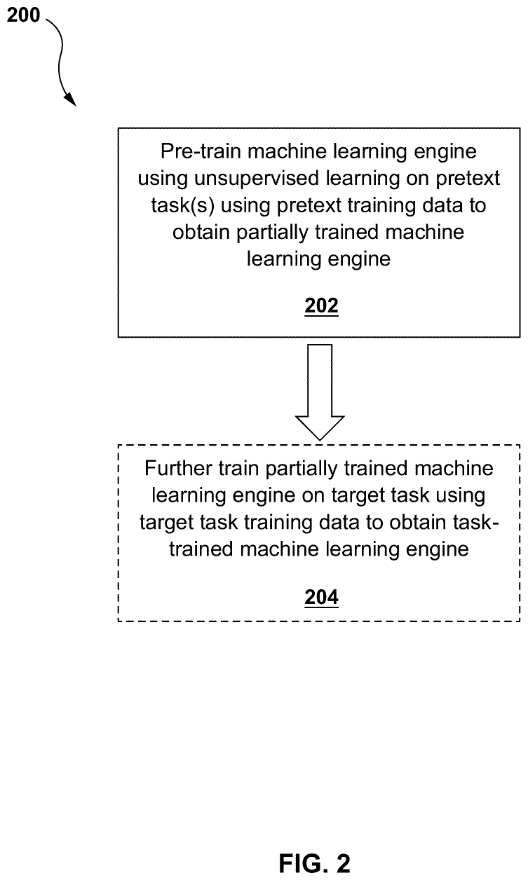

Reference is now made to FIG. 2, which is a flow chart showing an illustrative method 200 for training a machine learning engine for event sequence tasks, consistent with the illustrative method 100 shown schematically at FIG. 1.

At step 202, the machine learning engine is trained using unsupervised learning on at least one pretext task using pretext training data to obtain a partially trained machine learning engine. The pretext training data used at step 202 comprises pretext event sequences, which may be regular event sequences or asynchronous event sequences.

After pre-training the machine learning engine to obtain the partially trained machine learning engine at step 202, at optional step 204 the partially trained machine learning engine is further trained on a target task using target task training data to obtain a task-trained machine learning engine. The target task training data used at step 204 comprises target task event sequences, which may be regular event sequences or asynchronous event sequences.

### Overview of Illustrative Pre-Training (Pretext) Tasks

### Masked Reconstruction

A widely used pretext task in many research fields is masked reconstruction (He et al., 2022; Devlin et al., 2018). These approaches randomly remove part of the data (e.g., pixels, words or time series values) and train the model (i.e. a machine learning engine) to fill in the masked part through a high-level understanding of the neighboring context. As will be explained further below, one aspect of the present disclosure applies a tailored mask token sampling strategy specific to event sequence data.

### Contrastive Learning

Contrastive learning is another popular pretext task where the training goal is to bring different views of the same data together while pushing views of different data apart (Chen et al., 2020). To construct different views, a variety of augmentation schemes have been explored (Tian et al., 2020; Zhang et al., 2023). However, it had remained unclear whether these augmentation schemes could apply to event sequence data. As detailed further below, one aspect of the present disclosure applies contrastive learning to event sequence data, including the following views: (i) sub-sequence sampling, (ii) adding noise to embeddings, and (iii) randomly masking out data.

### Alignment Learning

Alignment learning approaches have seen significant interest in cross-modality learning research. Alignment learning generally defines a binary classification problem of predicting misaligned/aligned data (e.g., vision-audio/language or shuffled video clips) as a pretext task for pre-training (Chung et al., 2019; Miech et al., 2020; Misra et al., 2016; Luo et al., 2020). As will be explained further below, one aspect of the present disclosure describes the use of alignment learning (alignment loss) to pre-train a machine learning engine implementing an event sequence model, with a particular focus on verifying the correct coupling of event type and time.

### Temporal Point Process

Temporal point process (TPP) (Daley et al., 2003) is a mathematical tool for modeling the occurrence of asynchronous discrete events. Depending on their approaches to modeling the distribution of events happening over time, TPPs can be broadly categorized into intensity-based (Zuo et al., 2020; Mei & Eisner, 2017) and intensity-free models (Shchur et al., 2019). The former approach parameterizes an intensity function of time to determine the probability of event occurrence. In contrast, the latter approach directly models the distribution of time intervals between event occurrences. Models for sequential data like recurrent neural networks have been an important building block of neural TPP models (Mei et al., 2019; Mehrasa et al., 2019). Other TPP efforts focus on using transformer blocks (Vaswani et al., 2017) to build attentive TPP for better performance (Mei et al., 2021) as well as leveraging more advanced learning formulas, such as meta-learning (Bae et al., 2023). This meta-learning approach, also referred to as Meta-TPP, is described in U.S. patent application Ser. No. 18/460,478 filed Sep. 1, 2023 and Canadian Patent Application No. 3,211,408 filed on Sep. 7, 2023, each of which are hereby incorporated by reference. The reviews by Shchur et al., 2021 and Xue et al., 2023 describe a variety of TPP models. One aspect of the present disclosure also describes the application of TPP techniques to event sequence data.

### Application of Pretext Training to Event Sequences

The present disclosure describes application of self-supervised pre-training to event sequences as a stand-alone module that operates by running pretext tasks, preferably by jointly running multiple pretext tasks. The self-supervised pre-training is independent of downstream tasks and does not entail any labeled data. Three non-limiting, illustrative pretext tasks are described: (i) a masking and reconstruction task that is applied on both event type and time, (ii) a contrastive learning task that uses augmentations to generate positive and negative views of data, and (iii) a special alignment verification task that drives the models implemented by the machine learning engine to learn the intrinsic consistency between feature dimensions.

### Event Sequences

A realization of event sequences can be expressed X={(t₁, m₁), . . . , (t_{N}, m_{N})}, where N is the total number of events, {tᵢ} are arrival times (e.g., scalars) and {mᵢ} are the event types (e.g., categorical variables with size of K) and/or event values. In some embodiments, a realization of event sequences may be expressed as X={(t₁, m₁, n₁), . . . , (t_{N}, m_{N}, n_{N})}, where {mᵢ} is a categorical variable representing an event type and {nᵢ} is a scalar variable representing an event value. In some embodiments, there may be more than one event type and/or more than one event value. The technology described in the present disclosure is not limited to any specific type of event sequence representation, but may be applied to any amenable event sequence data. In the event sequence context, the objective is to model the probability distribution of the event time and type, P(tᵢ, mᵢ|hᵢ), where hᵢ is the embedding of the past events at time t.

The primary goal is to pre-train the machine learning engine as a generalized backbone that can then be fine-tuned for various downstream target tasks, such as TPP, classification or interpolation, for example. A suitable machine learning engine backbone is one that can support diverse pretext tasks and is readily fine-tuned.

In one preferred embodiment, the target task is a TPP task performed using a transformer, which may be a Hawkes transformer. Thus, one illustrative, non-limiting machine learning engine that can serve as a generalized backbone is the Attentive Neural Hawkes Process (ANHP) (Mei et al., 2021). The ANHP has a transformer architecture that requires minimal adaptation to work with the pre-training tasks described herein, and learns an intensity function to approximate TPP distributions (Bae et al., 2023; Shi et al., 2023). Event information may be encoded as follows under this setting:
Event time embeddings. Positional encodings (Vaswani et al., 2017) are used to transform each event timestamp into vectors, eₜ∈R^{D}^{ₜᵢₘₑ}; and
Event type embeddings. Categorical event types are encoded into a high dimensional vector, eₘ∈R^{D}^{_{type}}, with a learnable embedding layer, similar to Du et al. (2016).
   The final input to the pre-training model implemented by the machine learning engine is the concatenation of e=[eₘ, eₜ].

### Masked Reconstruction

Event data can be viewed as sequential signals similar to natural language sentences. Without being limited by theory, it is conjectured that it is valuable to capture the global or local contextual information. To this end, one pretext task is to reconstruct masked event data.

### Density-Preserving Masking.

Masked reconstruction is one of the most popular self-supervised learning approaches in vision and language and has recently been extended to the time series domain with masking of continuous fragments (Zerveas et al., 2022). Technology according to the present disclosure adopts a density-preserving masking strategy (Chowdhury et al., 2023) motivated by the non-uniform nature of events arrival times. Thus, in a preferred embodiment the masked reconstruction 112 (FIG. 1) comprises density-preserving masking. This approach randomly samples intervals with constant time duration and masks all the events in the periods. The underlying hypothesis is that time intervals with dense events contain more contextual information than time intervals with sparse events, making the reconstruction of events much easier in time intervals with dense events. Therefore, a suitable masking strategy would preserve the original density of event arrival times, i.e., masking more events when event arrivals become more frequent. The constant time duration masking meets this requirement. In some embodiments, a 30% masking ratio on time duration was found to be sufficient. Masking may be achieved by replacing the masked events with a learnable [MASK] token (He et al., 2022; Devlin et al., 2018).

### Reconstruction

The full set of embeddings consisting of (i) visible event embeddings and (ii) mask tokens is fed to the machine learning engine implementing the model to extract features corresponding to the special [MASK] token. Then, the features are decoded into event time and type embeddings using mean squared error (MSE), respectively; empirical results show that reconstructing embeddings is superior to reconstructing time stamps and event types with MSE and cross-entropy loss although the latter technique may also be used. Denote by subtitle M the masked event time and type embedding. The masked reconstruction loss is

$${ℒ}_{rec} ( θ ) = \frac{1}{\vert M \vert} {\sum }_{i ∈ M} {‖ {e}_{t , i} - {\tilde{e}}_{t , i} ‖}_{2}^{2} + {‖ {e}_{m , i} - {\tilde{e}}_{m , i} ‖}_{2}^{2} \qquad ( 1 )$$

where θ is the trainable parameters and (e_{t,i}, \tilde{e}_{t,i}) denotes the reconstructed event time and type embeddings, respectively.

### Contrastive Learning

To encourage the model implemented by the machine learning engine to capture the similarities of event sequence data to learn similar representations for event sequences close to each other, pre-training with contrastive learning may be deployed. Contrastive learning relies on augmentation methods to create multiple views of data. However, augmenting event sequences has long been a challenging problem. Aspects of the present disclosure describe three illustrative, non-limiting data augmentation methods that can be deployed for event sequence data.

### Sub-Sequence Augmentation

For this technique, sub-sequences are randomly extracted from the original data and treated as novel views (Yue et al., 2022; Chowdhury et al., 2023). Subsequences of event data represent a local division of original data, and therefore, without being limited by theory, are expected to improve contrastive learning. One illustrative, non-limiting approach creates subsequences by taking events after sampled timestamps in the original sequences.

### Masked Event Augmentation

The second augmentation method further exploits the use of masked data described above to create novel views. Existing masked autoencoder research (He et al., 2022) and the use of masked reconstruction as described above show that the model implemented by the machine learning method can learn to reconstruct the masked data from the contextual information. Therefore, without being limited by theory, masked data should bear the same semantic meaning as the original data, and contrastive learning based on masked data can further enhance the model representation's disparity between similar and non-similar sequences.

### Noisy Data Augmentation

Multi-scale Gaussian noise can be added to the event sequence embeddings which, once so augmented, can be taken as novel views. Compared to sub-sequence augmentation and masked event augmentation, noisy input is a type of data corruption closer to real-world settings. A good representation is preferably robust to noise corruption (Vincent et al., 2008). Therefore, noisy versions of event sequences may be a valuable component of multi-view data for contrastive learning. In one illustrative embodiment, the following steps are taken to inject noise into data:
(i) Uniformly sampling the scale of noise, σ∈[0,1]; and
(ii) Sampling Gaussian noise from N(0, σ).

The sampled noise is added to the embeddings.

To compute the contrastive loss, the entire sequence should be represented with one vector. In one embodiment, a special [CLS] token may be appended to the end of event sequences and the output feature corresponding to [CLS], i.e., z, may be used as the aggregated representation. In the illustrated embodiment, all three augmentation methods are used for each data in the mini-batch the normalized temperature-scaled cross entropy loss (NT-Xent) (Chen et al., 2020) is adapted to fit the setting. Given a mini batch of training data of size B, Sᵢ is used to denote the set consisting of the embedding of the i^{th} sample and the embeddings of all its three augmented views. S=∪Sᵢ is used to denote the union of all {Sᵢ}. Denote P_{S}_{ᵢ}² as the set of all combinations of two different embeddings from Sᵢ with permutation (positive pair), which is {z, ź|z, ź∈Sᵢ and z≠ź}. Each P_{S}_{ᵢ}² contains 12 elements as the size of Sᵢ is 4. We define the contrastive loss for i^{th} sample lᵢ as

$${l}_{i} = \frac{1}{12} {\sum }_{( z , {z}^{′} ∈ {P}_{{S}_{i}}^{2} )} log \frac{exp ( z \cdot {z}^{′} / η )}{{\sum }_{{z}^{{\sim}^{′}} ∈ S - \{ z \}} exp ( z \cdot {z}^{{\sim}^{′}} / η )} . \qquad ( 2 )$$

The final contrastive loss [symbol] is calculated as

$${ℒ}_{cl} = \frac{1}{B} {\sum }_{i}^{B} {l}_{i} .$$

Thus, in certain embodiments the contrastive learning 114 (FIG. 1) comprises at least one of sub-sequence augmentation, masked event augmentation, and noisy data augmentation.

### Alignment Verification

The machine learning engine implementing the model may also be pre-trained by verifying alignment. Two properties of event data may be observed:
(i) Event types are associated with the corresponding arrival times; and
(ii) Preceding events can determine subsequent events.
   For example, the event “lunch break” is often associated with noontime; and the occurrence of “purchase airline tickets” often results in “reserve hotel”. An effective model should recognize violations of these rules. Hence, verifying such alignment may be deployed as an aspect of model pre-training.

In a preferred embodiment, the alignment verification pretext task is designed as a binary classification problem, aiming to correctly distinguish aligned event sequences from misaligned event sequences. To generate misaligned event sequences for pre-training, several methods may be deployed, some non-limiting illustrative examples of which are described below.

### Random Shuffle

In event sequences, event types are conjugated with arrival times. So, a naive way to disrupt the consistency is to randomly shuffle one dimension while keeping another intact. Empirically, random shuffling on the event time has been found to be sufficient, although this is not intended to be limiting.

### Random Swapping

Similarly to the random shuffle approach, a misalignment may be created by mixing event types of a given sequence with event times of another sequence. This can be done by randomly picking a different event sequence in the same batch and swapping the respective type and time dimensions.

### Random Combination

The previous two approaches focus on creating misalignment on one feature dimension, i.e., the event time. Another approach intertwines two event sequences on both dimensions. One implementation of this approach randomly combines halves of two arbitrary sequences on both event type and time.

Similar to the contrastive learning approach, the feature output of the [CLS] token may be used as input to a simple multi-layer perceptron (MLP) classifier and the binary cross-entropy loss, [symbol] may be computed.

Thus, as shown in FIG. 1D, in one embodiment the pretext training data 102 comprises pretext asynchronous event sequences 104 and the target task training data 122 comprises are target task asynchronous event sequences 124, and the alignment verification 116 may incorporate at least one of randomly shuffled views 150 of the pretext asynchronous event sequences 104, randomly swapped views 152 of the pretext asynchronous event sequences 104, and random combination views 154 of the pretext asynchronous event sequences 104.

### Learning Objective for Illustrative Pretext Tasks

In an embodiment which uses all of the above-described pretext tasks (masked reconstruction, contrastive learning and alignment verification), the loss may be calculated as the sum of these pretext tasks according to:

$${ℒ}_{pretext} = {λ}_{1} {ℒ}_{rec} + {λ}_{2} {ℒ}_{cl} + {λ}_{3} {ℒ}_{alignment} , \qquad ( 3 )$$

where {λᵢ} are the combination weights. The loss function may be suitably adapted where fewer or other pretext tasks are used.

### Experimental Results

### Datasets and Evaluation Protocol

The method described above (use of the masked reconstruction, contrastive learning and alignment verification pretext tasks as pre-training, with further training (fine-tuning) for TPP as the downstream target task) was evaluated on six datasets, including four representative real datasets and two synthetic datasets.

The four representative real datasets were StackOverflow (Leskovec & Krevl, 2014), Mooc (Leskovec & Krevl, 2014), Reddit (Leskovec & Krevl, 2014), and MIMIC-II (Lee et al., 2011). The two synthetic datasets were “Missing” and “Hawkes”.

In addition, two irregular time series datasets were used to show that the method can be generalized; these were PhysioNet and Human Activity.

### StackOverflow Dataset

The StackOverflow (SO) dataset (Leskovec & Krevl, 2014) includes sequences of user awards within two years. StackOverflow (url: www.stackoverflow.com) is a question-answering website where users receive awards based on their proposed questions and their answers to questions proposed by others. This dataset contains in total 6,633 sequences. There are 22 types of events: Nice Question, Good Answer, Guru, Popular Question, Famous Question, Nice Answer, Good Question, Caucus, Notable Question, Necromancer, Promoter, Yearling, Revival, Enlightened, Great Answer, Populist, Great Question, Constituent, Announcer, Stellar Question, Booster and Publicist.

The award time records when a user receives an award. With this dataset, a machine learning engine can learn which type of awards will be given to a user and when.

### Mooc Dataset

The Mooc dataset (Leskovec & Krevl, 2014) contains the interaction of students with an online course system. An interaction is an event and can be one of 97 unique types, including (e.g.) watching a video or solving a quiz.

### Reddit Dataset

The Reddit dataset (Leskovec & Krevl, 2014) is based on the “Reddit” social network website (www.reddit.com) where users submit posts to “subreddits”. In the dataset, the most active subreddits are selected, and posts from the most active users on those subreddits are recorded. Each sequence corresponds to a list of submissions a user makes. The data contains 984 unique subreddits that are used as classes in event type prediction.

### MIMIC-II Dataset

The Multiparameter Intelligent Monitoring in Intensive Care (MIMIC-II) dataset (Lee et al., 2011) was developed based on an electric medical record system. The dataset contains in total 650 sequences, each of which corresponds to an anonymous patient's clinical visits in a seven-year period. Each clinical event records the diagnosis result and the timestamp of that visit. The number of unique diagnosis results is 75. According to the clinical history, a temporal point process should capture the dynamics of when a patient will visit doctors and what the diagnostic result will be.

### “Missing” and “Hawkes” Datasets

The “Missing” and “Hawkes” datasets each comprise synthetic data (Zuo et al., 2020). Each of these two datasets contains 10,000 event sequences yielding 5-dimensional Hawkes processes. The event sequences in the Missing dataset are censored randomly, which imitates real-world scenarios with missing events.

### PhysioNet Dataset

The “PhysioNet” dataset (Silva et al., 2012) is a multivariate time series dataset consisting of 37 physiological variables, respectively, extracted from intensive care unit (ICU) records. Each record contains sparse and irregularly spaced measurements from the first 48 hours after admission to the ICU. In-hospital mortality (a binary classification) can be predicted from this dataset.

### Human Activity Dataset

The Human Activity dataset (Kaluza et al., 2010) has 3-D positions of the waist, chest, and ankles from 5 individuals performing activities including walking, sitting, lying, and standing.

### Implementation Details

Transformer-based models (Mei et al., 2021) were used as the backbone, with additional heads introduced for masked reconstruction and alignment verification. The model used for the experiments was a transformer of three blocks and four heads with the time and event features' dimensions being 32. The learning rate was fixed at 0.0001, the training epochs were 300, and the batch size was set to 4 to align with the baseline Attentive Neural Hawkes Process (ANHP). For contrastive learning, the embedding at the special token [CLS] was used. For the reconstruction head, a 3-layer MLP with Rectified Linear Unit (ReLU) (32→32→32→32) was used. For the alignment verification head, a linear transformation was used to classify whether the input sequence is fake. For simplicity, the parameters were set as α=β=γ=1. {λᵢ} is set to 1. The foregoing paragraph is merely an illustrative implementation for experimental purposes and is not intended to be limiting.

### Next Event Prediction Results

The use of the combination of masked reconstruction, contrastive learning and alignment verification pretext tasks as pre-training, with further training (fine-tuning) for TPP as the downstream target task, was evaluated for each of the real datasets and the synthetic datasets. The results for the real datasets are shown in Table 1 and the results for the synthetic datasets are shown in Table 2. The term “Pretext” denotes the results for the method described herein, and best results are shown in bold.

TABLE 1
Next time and event prediction (RMSE, NLL, and accuracy) on Stack Overflow, Mooc, Reddit, and MIMIC-II.

| | Stack Overflow | | | Mooc | | | Reddit | | | MIMIC-II | | |
|---|---|---|---|---|---|---|---|---|---|---|---|---|
| | RMSE | NLL | Acc | RMSE | NLL | Acc | RMSE | NLL | Acc | RMSE | NLL | Acc |
| Methods | ↓ | ↓ | ↑ | ↓ | ↓ | ↑ | ↓ | ↓ | ↑ | ↓ | ↓ | ↑ |
| Intensity- | 3.64 (0.26) | 3.66 (0.02) | 0.43 (0.005) | 0.31 | 0.94 | 0.40 | 0.18 | 1.09 | 0.60 | — | — | — |
| free | | | | | | | | | | | | |
| Neural flow | — | — | — | 0.47 | 0.43 | 0.30 | 0.32 | 1.30 | 0.60 | — | — | — |
| THP+ | 1.68 (0.16) | 3.28 (0.02) | 0.46 (0.004) | 0.18 | 0.13 | 0.38 | 0.26 | 1.20 | 0.60 | — | — | — |
| Attentive | 1.15 (0.02) | 2.64 (0.02) | 0.46 (0.004) | 0.16 | −0.72 | 0.36 | 0.11 | 0.03 | 0.60 | — | — | — |
| TPP | | | | | | | | | | | | |
| ANHP | 1.19 (0.01) | 2.16 (0.02) | 0.47 (0.43) | 0.20 | −2.70 | 0.21 | 0.19 | 0.07 | 0.63 | 1.07 | 1.68 | 0.85 |
| Pretext | 1.05 (0.11) | 1.81 (0.05) | 0.50 (0.28) | 0.19 | −4.00 | 0.32 | 0.19 | −0.26 | 0.59 | 1.06 | 1.48 | 0.86 |

TABLE 2
Next time and event prediction (RMSE, NLL, and Accuracy)
on two representative synthetic datasets (Missing and Hawkes).

| | Missing | | | Hawkes | | |
|---|---|---|---|---|---|---|
| | RMSE | NLL | Acc | RMSE | NLL | Acc |
| Methods | ↓ | ↓ | ↑ | ↓ | ↓ | ↑ |
| ANHP | 0.5041 | 1.5020 | 0.4134 | 0.4040 | 1.3975 | 0.3813 |
| Pretext | 0.5003 | 1.4716 | 0.4135 | 0.4517 | 1.3681 | 0.3815 |

As can be seen in Tables 1 and 2, the methods described herein outperform the previous methods on the negative log likelihood (NLL) metric and are comparable on Accuracy and Root Mean Squared Error (RMSE).

### Generalization on Irregular Time Series

The performance of the combination of masked reconstruction, contrastive learning and alignment verification pretext tasks as pre-training was also evaluated for the irregular time series datasets for event prediction (TPP) for classification as the downstream target task and for interpolation as the downstream target task. “ODE-RNN” refers to a generalization of recurrent neural networks (RNNs) to have continuous-time hidden dynamics defined by ordinary differential equations (ODEs) (Rubanova et al., 2019). The acronym “mTAND” refers to Multi-Time Attention Networks for irregularly sampled time series (Shukla et al., 2021). “PrimeNet” (Chowdhury et al., 2023) is a process of pre-training for irregular multivariate time series. These results are shown in Table 3, with best results shown in bold (higher is better for classification and lower is better for interpolation, the asterisk (*) denotes results reproduced using public official codes. “AUC” refers to area under the receiver operating characteristic (ROC) curve.

TABLE 3
Classification (AUC) and interpolation (RMSE)
results on PhysioNet and Human Activity.

| | |
|---|---|
| PhysioNet | Human Activity |

| Methods | Cls. ↑ | Inp. ↓ | Cls. ↑ | Inp. ↓ |
|---|---|---|---|---|
| ODE-RNN | 0.694 | 26.69 | 0.885 | 11.91 |
| mTAND | 0.837 | 20.46 | 0.918 | 6.89 |
| PrimeNet | 0.842 | 14.30 | 0.913 | 4.78* |
| Pretext | 0.852 | 6.59 | 0.922 | 4.56 |

### Effect of Different Pretext Tasks

To evaluate the contribution of each pretext task, ablation experiments were conducted and the results are presented in Table 4. The baseline (ANHP), which does not employ any specific pre-training strategies, serves as a reference point for comparison. When individually applying each pre-training strategy, the results indicate consistent improvements on the main NLL metric. Specifically, masked reconstruction (“Rec.”) improves the NLL from 2.16 to 1.86, contrastive learning (“Cont.”) improves the NLL from 2.16 to 1.84, and alignment verification (“Align.”) improves the NLL from 2.16 to 1.86. Further, to see how each pre-training strategy works with each other pre-training another, additional experiments were conducted; these are also shown in Table 4. The results show that combining contrastive learning with alignment verification works the best of each two-strategy combination, with the lowest NLL of 1.82, RMSE of 1.07, and accuracy of 49.75%. Ultimately, the most compelling results are achieved when all three pre-training strategies are employed together. This comprehensive approach produces the lowest NLL (1.79). Consequently, the integrated strategy emerges as the most effective means of enhancing the performance of the pretext training strategies described herein.

TABLE 4
NLL, RMSE and Accuracy of pre-training methods with different
pre-training strategies; “Rec.” refers to masked reconstruction,
“Cont.” refers to contrastive learning and “Align.” refers to
alignment verification.

| Methods | Rec. | Cont. | Align. | NLL ↓ | RMSE ↓ | Acc ↑ |
|---|---|---|---|---|---|---|
| Baseline | | | | 2.16 | 1.19 | 47.42 |
| Pretext | ✓ | | | 1.86 | 1.13 | 49.68 |
| | | ✓ | | 1.84 | 1.16 | 49.80 |
| | | | ✓ | 1.86 | 1.36 | 47.96 |
| | ✓ | ✓ | | 1.83 | 1.13 | 49.28 |
| | ✓ | | ✓ | 1.84 | 1.23 | 49.81 |
| | | ✓ | ✓ | 1.82 | 1.07 | 49.75 |
| | ✓ | ✓ | ✓ | 1.81 | 1.05 | 49.69 |

### Few-Shot Pretext Training

The ability of the pretext training method to generalize in few-shot settings was also examined. A subset of the relevant dataset during both the pretext training and the further training (fine-tuning) stages was used to investigate this aspect. Specifically, 25%, 50%, and 75% of the entire training dataset were utilized and the performance of the trained machine learning engine on the complete test dataset was subsequently evaluated. To mitigate the effects of randomness, the average results obtained from three different random seeds are reported. The experimental results are presented in Table 5.

TABLE 5
Few-shot ability of the pretext-trained model using a subset containing
25%, 50% or 75% of the training or pretext training data, reporting
NLL, RMSE and Accuracy; “PT” and “TR” refer to
the ratio of pretext training data and training data, respectively.

| Methods | PT | TR | NLL ↓ | RMSE ↓ | Acc ↑ |
|---|---|---|---|---|---|
| Baseline | — | 0.25 | 2.19 | 1.18 | 46.34 |
| | | 0.5 | 2.19 | 1.19 | 47.13 |
| | | 0.75 | 2.16 | 1.19 | 47.35 |
| | | 1 | 2.16 | 1.19 | 47.42 |
| Pretext | 1 | 0.25 | 1.88 | 1.17 | 49.72 |
| | 1 | 0.5 | 1.86 | 1.03 | 49.75 |
| | 1 | 0.75 | 1.87 | 1.24 | 49.72 |
| | 0.25 | 1 | 1.92 | 1.11 | 49.14 |
| | 0.5 | 1 | 1.87 | 1.14 | 49.90 |
| | 0.75 | 1 | 1.85 | 1.10 | 49.71 |
| | 1 | 1 | 1.81 | 1.05 | 49.69 |

### Impact of Data Augmentation Methods (Contrastive Learning)

Experiments were conducted in respect of each component in contrastive learning, with the results reported in Table 6. When using the data augmentation methods separately, there are minor improvements for the contrastive training techniques according to the present disclosure as compared with conventional contrastive training. And combining the subsequence approach with the masked events approach yields the best performance when using two data augmentation strategies together. Notably, the combination of subsequence masking, masking augmentation, and noise addition augmentation yields the most favorable outcomes. This configuration results in the lowest NLL score of 1.84, the smallest RMSE of 1.16, and a high accuracy of 49.80. These findings emphasize the effectiveness of comprehensive data augmentation strategies in enhancing the quality and precision of predictions for a machine learning engine according to the present disclosure, underscoring the significance of these techniques in the context of contrastive learning for event sequence data.

TABLE 6
NLL, RMSE and Accuracy of pretext training method using
different data augmentation strategies for contrastive learning.
“Sub.”, “Mask.” and “Noise” refer to the proposed
subsequence, masking and noise addition strategies.

| Methods | Sub. | Mask. | Noise | NLL ↓ | RMSE ↓ | Ac ↑ |
|---|---|---|---|---|---|---|
| Baseline | | | | 2.16 | 1.19 | 47.42 |
| Pretext | | | | 1.92 | 1.10 | 49.65 |
| | ✓ | | | 1.90 | 1.07 | 49.64 |
| | | ✓ | | 1.89 | 1.13 | 49.55 |
| | | | ✓ | 1.90 | 1.05 | 49.8 |
| | ✓ | ✓ | | 1.85 | 1.32 | 49.89 |
| | ✓ | | ✓ | 1.88 | 1.20 | 49.73 |
| | | ✓ | ✓ | 1.86 | 1.19 | 49.70 |
| | ✓ | ✓ | ✓ | 1.84 | 1.16 | 49.80 |

### Impact of Alignment Verification Strategy

Experiments were conducted in respect of how different alignment verification strategies work with each other, with the results reported in Table 7. When only employing one alignment verification strategy, the random combination is the most effective method regarding NLL, while swapping achieves the best/lowest RMSE. When using two different strategies, the combination of random combination and random swapping peaks with the lowest NLL of 1.84, lowest RMSE of 1.20, and a comparable accuracy of 49.75%. Finally, combining three strategies together obtains a comparable result on NLL, RMSE, and accuracy, which, without being limited by theory, might be due to the randomness of creating three different misalignment examples.

TABLE 7
NLL, RMSE and Accuracy of pretext training method using
different alignment verification strategies. “Comb.”, “Swap.”,
and “Shuf.” Refer to the proposed random combination,
random swapping and random shuffle strategies.

| Methods | Comb. | Swap. | Shuf. | NLL ↓ | RMSE ↓ | Acc ↑ |
|---|---|---|---|---|---|---|
| Baseline | | | | 2.16 | 1.19 | 47.42 |
| Pretext | ✓ | | | 1.86 | 1.23 | 49.70 |
| | | ✓ | | 1.90 | 1.17 | 49.72 |
| | | | ✓ | 1.86 | 1.92 | 49.85 |
| | ✓ | ✓ | | 1.85 | 1.20 | 49.75 |
| | ✓ | | ✓ | 1.86 | 2.09 | 49.88 |
| | | ✓ | ✓ | 1.88 | 1.24 | 49.72 |
| | ✓ | ✓ | ✓ | 1.86 | 1.36 | 47.96 |

### Model Depth

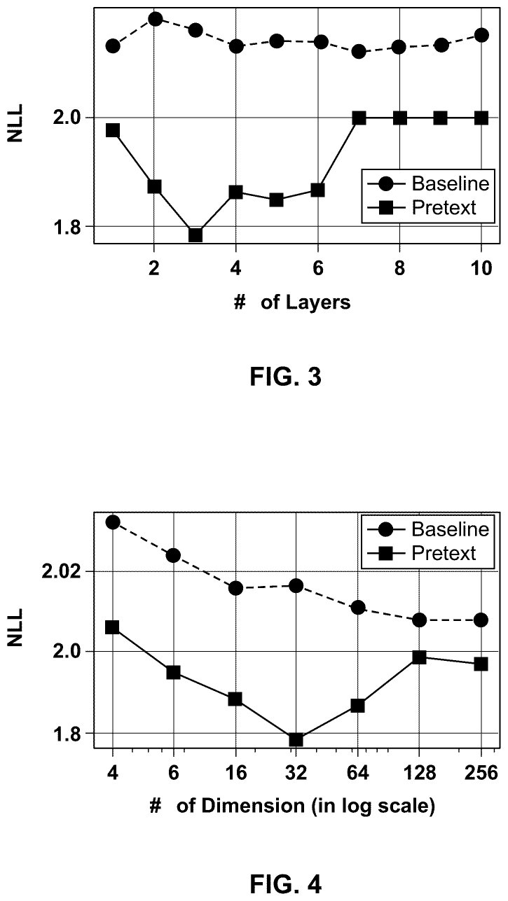

Experiments were conducted using the StackOverflow dataset to understand the impact of the number of transformer blocks, varying the depth (number of layers) from 1 to 6 as shown in FIG. 3. The baseline model (ANHP) exhibits relatively consistent but suboptimal performance across the range of layers, with NLL values ranging from 2.13 to 2.18. In contrast, a machine learning engine according to the present disclosure (pre-trained with pretext tasks using unsupervised learning) consistently outperforms the baseline, demonstrating a progressive improvement in NLL from 1.9778 with one layer to 1.8326 with six layers. It underscores the effectiveness of this architecture in enhancing performance, suggesting that increasing the number of layers contributes to improved performance with the pretext training methods described herein.

### Model Width

Experiments were conducted using the StackOverflow dataset to understand how wide the model should be (the feature dimension) as shown in FIG. 4. In the experiments, a machine learning engine according to the present disclosure consistently outperforms the baseline (ANHP) across all dimensionality settings, starting with a lower NLL of approximately 2.06 for 4 dimensions and achieving the lowest NLL of about 1.81 for 32 dimensions. Within the experiments conducted, the best performance of a machine learning engine according to the present disclosure is achieved by setting the feature dimension to 32. After that, the NLL increases with increasing feature dimension as, showing that a machine learning engine according to the present disclosure is able to learn a reasonable representation with a limited number of features.

### Technological Implementation

As can be seen from the above description, the use of pretext tasks for unsupervised learning on event sequence tasks as described herein represents significantly more than merely using categories to organize, store and transmit information and organizing information through mathematical correlations. The use of pretext tasks for unsupervised learning on event sequence tasks is in fact an improvement to the technology of machine learning, providing a learning framework for event sequence data that can produce generalizable and transferable representations that can be further trained (fine-tuned) for specific tasks. This can obviate the need to retrain an entire event sequence model to perform different downstream tasks. As such, the technology described herein is confined to machine learning applications in the context of event sequence data. Moreover, by avoiding the need to retrain an entire event sequence model to perform different downstream tasks, significant amounts of additional processing are avoided, thereby improving the overall performance of the computer system.

The present technology may be embodied within a system, a method, a computer program product or any combination thereof. The computer program product may include a computer readable storage medium or media having computer readable program instructions thereon for causing a processor to carry out aspects of the present technology. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present technology may be assembler instructions, instruction-set-architecture (ISA) instructions, machine instructions, machine dependent instructions, microcode, firmware instructions, state-setting data, or either source code or object code written in any combination of one or more programming languages, including an object oriented programming language or a conventional procedural programming language. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to implement aspects of the present technology.

Aspects of the present technology have been described above with reference to flowchart illustrations and/or block diagrams of methods, apparatus (systems) and computer program products according to various embodiments. In this regard, the flowchart and block diagrams in the Figures illustrate the architecture, functionality, and operation of possible implementations of systems, methods and computer program products according to various embodiments of the present technology. For instance, each block in the flowchart or block diagrams may represent a module, segment, or portion of instructions, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Some specific examples of the foregoing may have been noted above but any such noted examples are not necessarily the only such examples. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions may also be stored in a computer readable storage medium that can direct a computer, other programmable data processing apparatus, or other devices to function in a particular manner, such that the instructions stored in the computer readable storage medium produce an article of manufacture including instructions which implement aspects of the functions/acts specified in the flowchart and/or block diagram block or blocks. The computer readable program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

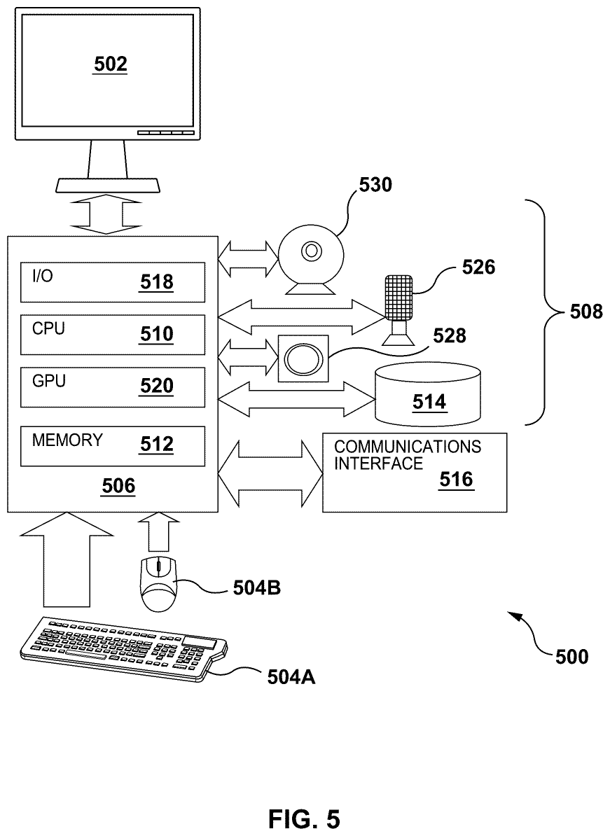

An illustrative computer system in respect of which the technology herein described may be implemented is presented as a block diagram in FIG. 5. The illustrative computer system is denoted generally by reference numeral 500 and includes a display 502, input devices in the form of keyboard 504A and pointing device 504B, computer 506 and external devices 508. While pointing device 504B is depicted as a mouse, it will be appreciated that other types of pointing device, or a touch screen, may also be used.

The computer 506 may contain one or more processors or microprocessors, such as a central processing unit (CPU) 510. The CPU 510 performs arithmetic calculations and control functions to execute software stored in an internal memory 512, preferably random access memory (RAM) and/or read only memory (ROM), and possibly additional memory 514. The additional memory 514 may include, for example, mass memory storage, hard disk drives, optical disk drives (including CD and DVD drives), magnetic disk drives, magnetic tape drives (including LTO, DLT, DAT and DCC), flash drives, program cartridges and cartridge interfaces such as those found in video game devices, removable memory chips such as EPROM or PROM, emerging storage media, such as holographic storage, or similar storage media as known in the art. This additional memory 514 may be physically internal to the computer 506, or external as shown in FIG. 5, or both.

The computer system 500 may also include other similar means for allowing computer programs or other instructions to be loaded. Such means can include, for example, a communications interface 516 which allows software and data to be transferred between the computer system 500 and external systems and networks. Examples of communications interface 516 can include a modem, a network interface such as an Ethernet card, a wireless communication interface, or a serial or parallel communications port. Software and data transferred via communications interface 516 are in the form of signals which can be electronic, acoustic, electromagnetic, optical or other signals capable of being received by communications interface 516. Multiple interfaces, of course, can be provided on a single computer system 500.

Input and output to and from the computer 506 is administered by the input/output (I/O) interface 518. This I/O interface 518 administers control of the display 502, keyboard 504A, external devices 508 and other such components of the computer system 500. The computer 506 also includes a graphical processing unit (GPU) 520. The latter may also be used for computational purposes as an adjunct to, or instead of, the (CPU) 510, for mathematical calculations.

The external devices 508 include a microphone 526, a speaker 528 and a camera 530. Although shown as external devices, they may alternatively be built in as part of the hardware of the computer system 500.

The various components of the computer system 500 are coupled to one another either directly or by coupling to suitable buses.

The term “computer system”, “data processing system” and related terms, as used herein, is not limited to any particular type of computer system and encompasses servers, desktop computers, laptop computers, networked mobile wireless telecommunication computing devices such as smartphones, tablet computers, as well as other types of computer systems.

Thus, computer readable program code for implementing aspects of the technology described herein may be contained or stored in the memory 512 of the computer 506, or on a computer usable or computer readable medium external to the computer 506, or on any combination thereof.

Finally, the terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description has been presented for purposes of illustration and description, but is not intended to be exhaustive or limited to the form disclosed. Many modifications and variations will be apparent to those of ordinary skill in the art without departing from the scope of the claims. The embodiment was chosen and described in order to best explain the principles of the technology and the practical application, and to enable others of ordinary skill in the art to understand the technology for various embodiments with various modifications as are suited to the particular use contemplated.

One or more currently preferred embodiments have been described by way of example. It will be apparent to persons skilled in the art that a number of variations and modifications can be made without departing from the scope of the claims. In construing the claims, it is to be understood that the use of a computer to implement the embodiments described herein is essential.

### LIST OF REFERENCES

The following list of references is provided for convenience and without admission of any kind. Without restricting the generality of the foregoing, none of the references listed or cited herein is admitted to be relevant to any claim or to be citable as prior art.
Bae, W., Ahmed, M. O., Tung, F., and Oliveira, G. L. Meta temporal point processes. arXiv preprint arXiv: 2301.12023, 2023.
Brown, T., Mann, B., Ryder, N., Subbiah, M., Kaplan, J. D., Dhariwal, P., Neelakantan, A., Shyam, P., Sastry, G., Askell, A., et al. Language models are few-shot learners. Advances in neural information processing systems, 33:1877-1901, 2020.
Chen, T., Kornblith, S., Norouzi, M., and Hinton, G. A simple framework for contrastive learning of visual representations. In International conference on machine learning, pp. 1597-1607. PMLR, 2020.
Chowdhury, R. R., Li, J., Zhang, X., Hong, D., Gupta, R. K., and Shang, J. Primenet: Pre-training for irregular multivariate time series. In Proceedings of the AAAI Conference on Artificial Intelligence, 2023.
Chung, S.-W., Chung, J. S., and Kang, H.-G. Perfect match: Improved cross-modal embeddings for audio-visual synchronisation. In ICASSP 2019-2019 IEEE International Conference on Acoustics, Speech and Signal Processing (ICASSP), pp. 3965-3969. IEEE, 2019.
Daley, D. J., Vere-Jones, D., et al. An introduction to the theory of point processes: volume I: elementary theory and methods. Springer, 2003.
Devlin, J., Chang, M.-W., Lee, K., and Toutanova, K. Bert: Pre-training of deep bidirectional transformers for language understanding. arXiv preprint arXiv: 1810.04805, 2018.
Du, N., Dai, H., Trivedi, R., Upadhyay, U., Gomez-Rodriguez, M., and Song, L. Recurrent marked temporal point processes: Embedding event history to vector. In Proceedings of the 22nd ACM SIGKDD international conference on knowledge discovery and data mining, pp. 1555-1564, 2016.
Franceschi, J.-Y., Dieuleveut, A., and Jaggi, M. Unsupervised scalable representation learning for multivariate time series. Advances in neural information processing systems, 32, 2019.
He, K., Chen, X., Xie, S., Li, Y., Dolla'r, P., and Girshick, R. Masked autoencoders are scalable vision learners. In Proceedings of the IEEE/CVF conference on computer vision and pattern recognition, pp. 16000-16009, 2022.
Langley, P. Crafting papers on machine learning. In Langley, P. (ed.), Proceedings of the 17th International Conference on Machine Learning (ICML 2000), pp. 1207-1216, Stanford, CA, 2000. Morgan Kaufmann.
Lee, J., Scott, D. J., Villarroel, M., Clifford, G. D., Saeed, M., and Mark, R. G. Open-access MIMIC-II database for intensive care research. In 33rd Annual International Conference of the IEEE Engineering in Medicine and Biology Society, EMBC 2011, Boston, MA, USA, Aug. 30-Sep. 3, 2011, pp. 8315-8318. IEEE, 2011. doi: 10.1109/IEMBS.2011.6092050. URL https://dspace.mit.edu/bitstream/handle/1721.1/76538/MIMIC2_IEEE_EMBC_2011_rev1%5B2%5D.pdf%3Bjsessionid%3D6BD60A2D2B78F422EF4298A3205E0ED1?sequence%3D1.
Leskovec, J. and Krevl, A. SNAP Datasets: Stanford large network dataset collection. http://snap.stanford.edu/data, June 2014.
Liu, Z., Lin, Y., Cao, Y., Hu, H., Wei, Y., Zhang, Z., Lin, S., and Guo, B. Swin transformer: Hierarchical vision transformer using shifted windows. In Proceedings of the IEEE/CVF international conference on computer vision, pp. 10012-10022, 2021.
Luo, H., Ji, L., Shi, B., Huang, H., Duan, N., Li, T., Li, J., Bharti, T., and Zhou, M. Univl: A unified video and language pre-training model for multimodal understanding and generation. arXiv preprint arXiv: 2002.06353, 2020.
Mehrasa, N., Jyothi, A. A., Durand, T., He, J., Sigal, L., and Mori, G. A variational auto-encoder model for stochastic point processes. In Proceedings of the IEEE/CVF Conference on Computer Vision and Pattern Recognition, pp. 3165-3174, 2019.
Mei, H. and Eisner, J. M. The neural hawkes process: A neurally self-modulating multivariate point process. Advances in neural information processing systems, 30, 2017.
Mei, H., Qin, G., and Eisner, J. Imputing missing events in continuous-time event streams. In International Conference on Machine Learning, pp. 4475-4485. PMLR, 2019.
Mei, H., Yang, C., and Eisner, J. Transformer embeddings of irregularly spaced events and their participants. In International conference on learning representations, 2021.
Miech, A., Alayrac, J.-B., Smaira, L., Laptev, I., Sivic, J., and Zisserman, A. End-to-end learning of visual representations from uncurated instructional videos. In Proceedings of the IEEE/CVF Conference on Computer Vision and Pattern Recognition, pp. 9879-9889, 2020.
Misra, I., Zitnick, C. L., and Hebert, M. Shuffle and learn: unsupervised learning using temporal order verification. In Computer Vision—ECCV 2016: 14th European Conference, Amsterdam, The Netherlands, Oct. 11-14, 2016, Proceedings, Part I 14, pp. 527-544. Springer, 2016.
Radford, A., Wu, J., Child, R., Luan, D., Amodei, D., Sutskever, I., et al. Language models are unsupervised multitask learners. OpenAI blog, 1 (8): 9, 2019.
Radford, A., Kim, J. W., Hallacy, C., Ramesh, A., Goh, G., Agarwal, S., Sastry, G., Askell, A., Mishkin, P., Clark, J., et al. Learning transferable visual models from natural language supervision. In International conference on machine learning, pp. 8748-8763. PMLR, 2021.
Ren, S., He, K., Girshick, R., and Sun, J. Faster r-cnn: Towards real-time object detection with region proposal networks. In Neural Information Processing Systems (NIPS), 2015.
Yulia Rubanova, Y., Chen, R. and Duvenaud, D. Latent ODEs for Irregularly-Sampled Time Series. 33rd Conference on Neural Information Processing Systems (NeurIPS 2019), Vancouver, Canada.
Russakovsky, O., Deng, J., Su, H., Krause, J., Satheesh, S., Ma, S., Huang, Z., Karpathy, A., Khosla, A., Bernstein, M., et al. Imagenet large scale visual recognition challenge. International Journal of Computer Vision, 115 (3): 211-252, 2015.
Shchur, O., Biloš, M., and Günnemann, S. Intensity-free learning of temporal point processes. arXiv preprint arXiv: 1909.12127, 2019.
Shchur, O., Türkmen, A. C., Januschowski, T., and Günnemann, S. Neural temporal point processes: A review. arXiv preprint arXiv: 2104.03528, 2021.
Shi, X., Xue, S., Wang, K., Zhou, F., Zhang, J. Y., Zhou, J., Tan, C., and Mei, H. Language models can improve event prediction by few-shot abductive reasoning. arXiv preprint arXiv: 2305.16646, 2023.
Shukla, S. and Marlin, B. Multi-Time Attention Networks for Irregularly Sampled Time Series. Published as a conference paper at ICLR 2021. https://arxiv.org/pdf/2101.10318v2.pdf.
Tian, Y., Sun, C., Poole, B., Krishnan, D., Schmid, C., and Isola, P. What makes for good views for contrastive learning? Advances in neural information processing systems, 33:6827-6839, 2020.
Tonekaboni, S., Eytan, D., and Goldenberg, A. Unsupervised representation learning for time series with temporal neighborhood coding. arXiv preprint arXiv: 2106.00750, 2021.
Vaswani, A., Shazeer, N., Parmar, N., Uszkoreit, J., Jones, L., Gomez, A. N., Kaiser, L., and Polosukhin, I. Attention is all you need. Advances in neural information processing systems, 30, 2017.
Vincent, P., Larochelle, H., Bengio, Y., and Manzagol, P.-A. Extracting and composing robust features with denoising autoencoders. In Proceedings of the 25th international conference on Machine learning, pp. 1096-1103, 2008.
Xue, S., Shi, X., Chu, Z., Wang, Y., Zhou, F., Hao, H., Jiang, C., Pan, C., Xu, Y., Zhang, J. Y., et al. Easytpp: Towards open benchmarking the temporal point processes. arXiv preprint arXiv: 2307.08097, 2023.
Yue, Z., Wang, Y., Duan, J., Yang, T., Huang, C., Tong, Y., and Xu, B. Ts2vec: Towards universal representation of time series. In Proceedings of the AAAI Conference on Artificial Intelligence, volume 36, pp. 8980-8987, 2022.
Zerveas, George, et al. A transformer-based framework for multivariate time series representation learning. Proceedings of the 27th ACM SIGKDD conference on knowledge discovery & data mining. 2021.
Zerveas, G., Jayaraman, S., Patel, D., Bhamidipaty, A., and Eickhoff, C. A transformer-based framework for multivariate time series representation learning. In Proceedings of the 27th ACM SIGKDD conference on knowledge discovery & data mining, pp. 2114-2124, 2021.
Zhang, C., Yan, Q., Meng, L., and Sylvain, T. What constitutes good contrastive learning in time-series forecasting? arXiv preprint arXiv: 2306.12086, 2023.
Zuo, S., Jiang, H., Li, Z., Zhao, T., and Zha, H. Transformer hawkes process. In International conference on machine learning, pp. 11692-11702. PMLR, 2020.

What is claimed is:

1. A computer-implemented method for training a machine learning engine for event sequence tasks, the method comprising:
pre-training the machine learning engine using unsupervised learning on at least one pretext task using pretext training data to obtain a partially trained machine learning engine, wherein the pretext training data comprises pretext event sequences.

2. The method of claim 1, wherein the method further comprises:
after pre-training the machine learning engine to obtain the partially trained machine learning engine, further training the partially trained machine learning engine on a target task using target task training data to obtain a task-trained machine learning engine, wherein the target task training data comprises target task event sequences of a same type as the pretext event sequences.

3. The method of claim 2, wherein:
the pretext event sequences are pretext asynchronous event sequences; and
the target task event sequences are target task asynchronous event sequences.

4. The method of claim 2, wherein:
the pretext event sequences are pretext regular event sequences; and
the target task event sequences are target task regular event sequences.

5. The method of claim 2, wherein both the pretext training data and the target task training data are drawn from a single set of combined training data comprising a combined set of event sequences.

6. The method of claim 2, wherein the pretext training data are drawn from a first set of training data comprising a first set of event sequences and the target task training data are drawn from a second set of training data comprising a second set of event sequences.

7. The method of claim 6, wherein the first set of event sequences and the second set of event sequences are one of overlapping sets and mutually exclusive sets.

8. The method of claim 1, wherein the at least one pretext task comprises at least one of masked reconstruction, contrastive learning, and alignment verification.

9. The method of claim 1, wherein:
the pretext event sequences are pretext asynchronous event sequences;
the at least one pretext task comprises at least one alignment verification task; and
the at least one alignment verification task incorporates at least one of randomly shuffled views of the pretext asynchronous event sequences, randomly swapped views of the pretext asynchronous event sequences, and random combination views of the pretext asynchronous event sequences.

10. The method of claim 3, wherein the target task is a temporal point process (TPP) task.

11. The method of claim 2, wherein the target task is one of a classification task for irregular time series data and an interpolation task for irregular time series data.

12. A data processing system comprising at least one processor and memory coupled to the at least one processor, wherein the memory contains instructions which, when implemented by the at least one processor, cause the at least one processor to:
pre-train the machine learning engine using unsupervised learning on at least one pretext task using pretext training data to obtain a partially trained machine learning engine, wherein the pretext training data comprises pretext event sequences.

13. The data processing system of claim 12, wherein the memory contains instructions which, when implemented by the at least one processor, further cause the at least one processor to:
after pre-training the machine learning engine to obtain the partially trained machine learning engine, further train the partially trained machine learning engine on a target task using target task training data to obtain a task-trained machine learning engine, wherein the target task training data comprises target task event sequences of a same type as the pretext event sequences.

14. The data processing system of claim 12, wherein:
the pretext event sequences are pretext asynchronous event sequences; and
the target task event sequences are target task asynchronous event sequences.

15. The data processing system of claim 12, wherein:
the pretext event sequences are pretext regular event sequences; and
the target task event sequences are target task regular event sequences.

16. The data processing system of claim 12, wherein the first set of event sequences and the second set of event sequences are one of overlapping sets and mutually exclusive sets.

17. The data processing system of claim 12, wherein the at least one pretext task comprises at least one of masked reconstruction, contrastive learning, and alignment verification.

18. A computer program product comprising at least one tangible, non-transitory computer-readable medium embodying instructions which, when implemented by at least one processor of a data processing system, cause the at least one processor to:
pre-train the machine learning engine using unsupervised learning on at least one pretext task using pretext training data to obtain a partially trained machine learning engine, wherein the pretext training data comprises pretext event sequences.

19. The computer program product of claim 18, wherein the instructions, when implemented by the at least one processor, further cause the at least one processor to:
after pre-training the machine learning engine to obtain the partially trained machine learning engine, further train the partially trained machine learning engine on a target task using target task training data to obtain a task-trained machine learning engine, wherein the target task training data comprises target task event sequences of a same type as the pretext event sequences.

20. The computer program product of claim 18, wherein:
the pretext event sequences are pretext asynchronous event sequences; and
the target task event sequences are target task asynchronous event sequences.

21. The computer program product of claim 18, wherein:
the pretext event sequences are pretext regular event sequences; and
the target task event sequences are target task regular event sequences.

22. The computer program product of claim 18, wherein the first set of event sequences and the second set of event sequences are one of overlapping sets and mutually exclusive sets.

23. The computer program product of claim 18, wherein the at least one pretext task comprises at least one of masked reconstruction, contrastive learning, and alignment verification.
